(19) United States
(12) Patent Application Publication
(10) Pub. No.: US 2022/0263395 A1
(43) Pub. Date: Aug. 18, 2022

(54) Electric Actuating Unit

(71) Applicant: VOSS Automotive Valves and Actuators GmbH, Gründau (DE)

(72) Inventor: Ulrich Bürg, Raguhn-Jeßnitz (DE)

(21) Appl. No.: 17/721,466

(22) Filed: Apr. 15, 2022

Related U.S. Application Data
(63) Continuation of application No. PCT/IB2020/059820, filed on Oct. 19, 2020.

(30) Foreign Application Priority Data
Oct. 17, 2019 (DE) 102019128049.4

(51) Int. Cl. H02K 21/22; H02K 7/116; H02K 11/01; H02K 11/33

(52) U.S. Cl. CPC H02K 21/22; H02K 7/1166; H02K 2211/03; H02K 11/33; H02K 11/0141

(57) ABSTRACT

The present invention relates to an electric actuating unit comprising: a functional support that has a first receiving element; an electromagnetic coil arrangement that is fixedly attached to the first receiving element; and an arrangement of permanent magnets, which is arranged concentrically about the electromagnetic coil arrangement, in a rotor housing, said arrangement having a rotor shaft that is rotatably mounted in the first receiving element, wherein the electromagnetic coil arrangement and the arrangement of permanent magnets in a rotor housing form an external rotor motor

### BACKGROUND INFORMATION

### FIELD OF THE INVENTION

The invention relates to an electric actuating unit, in particular for use in motor vehicles.

### Discussion of Prior Art

Electric actuating units are known from the prior art and are used in many places in motor vehicles. Such electrical actuating units control, for example, mechanical flaps to exhaust silencers with flap control (e.g. Porsche, Harley-Davidson) or to shuts (closing lamellae in the radiator grille) for optimising aerodynamics. Usually, such an electric actuating unit receives a signal, whereupon the integrated motor is driven with a certain rotation to drive a gear ratio. This gear ratio in turn drives an adjustment element that makes up the functionality of the electric actuating unit, for example, a mechanical flap that opens or closes a bypass.

The problem with the known electric actuating units is that due to the large number of components to be combined to form an electric actuating unit, the probability of errors in their mass production increases, in particular errors in the manufacturing tolerances. It is therefore difficult and cost-intensive to produce a high quality with a reasonable effort.

As one solution, DE 10 2014 116 510 A1 describes an actuator unit comprising a motor having a shaft, an output member connected to the shaft, and a housing receiving the motor and having a first housing portion and a second housing portion, the first housing portion comprising a base and a mounting structure for mounting the motor to the housing. This known actuator is characterised in that the mounting structure is secured to a first edge region of the base by a connecting structure such that the mounting structure is cantilevered above the base. This technical solution is intended to create a low-noise actuator with only a few components, reliable performance and a simple manufacturing process. The two housing parts of this actuator unit also perform bearing tasks, which is to be considered a disadvantage in the present case. If the housing geometry of this actuator is changed, the complete component must be re-qualified (and certified if necessary), which means a very high effort.

What has not yet been taken into account in the state of the art is the problem of the manufacturing tolerances of the individual components of electric actuating units, which must be very precisely matched to each other for an optimal component. Each individual component must therefore have the lowest possible manufacturing tolerance. A further disadvantage is the arrangement of the individual components of the actuator unit described in DE 10 2014 116 510 Al (as well as other actuator units of the same type), in particular with respect to the motor, the gearbox, the downforce and finally the housing.

### BRIEF SUMMARY OF THE INVENTION

The invention is therefore based on the task of providing a new type of electric actuating unit, which can eliminate the disadvantages described above. In particular, it is a task of the present invention to comply with minimal tolerances on the production side without additional effort.

According to the invention, this task is solved by an electric actuating unit comprising
a function carrier (1), which has a first receiving element (101),
an electromagnetic coil arrangement (3) fixedly mounted on the first receiving element (101), and
an arrangement (5) of permanent magnets concentrically arranged around the electromagnetic coil arrangement (3) in a rotor housing, wherein the arrangement (5) has a rotor shaft (51) which is rotatably mounted in the first receiving element (101),
   wherein the electromagnetic coil arrangement (3) and the arrangement (5) of permanent magnets in a rotor housing form an external rotor motor.

The electric actuating unit according to the invention can be regarded as an integral component of parts with carrier functions, i.e. here the function carrier (1), and of components (3, 5) with motor functions. In other words, the function carrier (1) and the components (3, 5) with motor functions are integral parts of the electric actuating unit. A special feature is the integration of an external rotor motor into the electric actuating unit according to the invention, which is made possible by the function carrier (1) according to the invention.

The function carrier (1) is a one-piece component, which is designed to receive the functional components of the electric actuating unit according to the invention and to position them with minimal tolerances to each other. The function carrier (1) is preferably an injection-moulded component.

The first receiving element (101) is an integral part of the function carrier (1). It has an external shape corresponding to the electromagnetic coil assembly (3).

“Electromagnetic coil assembly” means a number of electrical coils or windings of stranded wires on a magnetic or magnetisable material. The phrase “fixedly attached” in this context means that the electromagnetic coil assembly (3) is force-locked with its body to the first receiving element (101), for example by pressing it on.

The arrangement (5) of permanent magnets in a rotor housing can be several individual permanent magnets, which are preferably arranged on the inside of the rotor housing. Alternatively, a ring can be provided as a permanent magnet. This ring is magnetised after its manufacture in such a way that the magnetic field strength between individual magnetic poles is arranged sinusoidally. This type of design of the permanent magnet arrangement enables uniform operation without cogging torque.

The phrase “arrangement (5) of permanent magnets” includes both alternatives.

The first receiving element (101), which is an integral part of the function carrier (1) according to the invention, has the important function for the electric actuating unit according to the invention of, on the one hand, receiving the electromagnetic coil arrangement (3) in a force-fitting, in particular form-fitting manner and, on the other hand, supporting the rotor shaft (51) of the arrangement (5) of permanent magnets in a rotor housing in a defined relation to the electromagnetic coil arrangement (3).

In the simplest case, the rotor housing is a rotationally symmetrical cylinder with the rotor shaft (51) as the axis of rotation, which is closed to one side in the shape of a cup. The permanent magnet(s) is/are arranged on the inside of this cylinder.

In the electric actuating unit according to the invention, the electromagnetic coil arrangement (3) and the arrangement (5) of permanent magnets in a rotor housing form an external rotor motor.

Compared to the known prior art, the present invention has the advantage that by providing the function carrier (1) according to the invention, several functions are combined in one single component. All tolerance-sensitive receptacles for further components such as the motor and drive elements are only taken over by the function carrier (1) according to the invention.

In order to maintain minimal tolerances, “only” precise manufacture of the function carrier (1) according to the invention is essentially necessary. However, since all tolerance-sensitive receptacles can be manufactured in a mould-specific manner, there are no longer any noticeable manufacturing tolerances. Manufacturing tolerances of other components of the electric actuating unit, on the other hand, such as in particular the housing, if present, and the housing cover, if present, no longer have any influence on the functional quality of the electric actuating unit according to the invention.

In particular, when the electric actuating unit according to the invention is installed in the engine compartment of a motor vehicle, there are very strong requirements for temperature resistance, vibration resistance, tightness, robustness and chemical resistance. As will become clear from the following definition of the features of the invention, the electric actuating unit according to the invention can meet these requirements.

Although external rotor motors are more elaborate to manufacture, more difficult to handle and more problematic to install or to bear in a component, it has been recognised in the present invention, contrary to these disadvantages, that important advantages according to the invention can be achieved with an external rotor motor.

The design of the external rotor motor developed according to the invention has a very small diameter compared to other electric motors. Since the diameter of the electric motor usually has a significant influence on the overall height of an electric actuating unit, the overall height of the electric actuating unit according to the invention can be significantly reduced compared to the prior art. The electric actuating unit according to the invention is thus lighter and smaller than all previously known actuator units.

Furthermore, it has been found that the volume output of the external rotor motor developed according to the invention, i.e. the volume occupied by the motor in relation to its output, is higher than that of conventional electric motors. As a result, the electric actuating unit according to the invention has a higher energy density than control units from the prior art.

In the prior art, the advantage of the higher power density is known in principle, but the use of external rotor motors fails due to the reliable mounting, since there is no fixed housing for mounting, but only the rotating external rotor towards the outside.

In contrast, the construction and layout of the function carrier (1) according to the invention is characterised by the fact that it meets the challenge of securely fastening and fully accommodating an external rotor motor and easily accommodates a motor design with external rotor mechanics while ensuring minimal tolerances.

In other words, the function carrier (1) according to the invention is designed in such a way that it does not simply accommodate a finished component “motor”, but forms a decisive basic element on which and with which the motor construction with external rotor motor mechanism is built.

In a further development of the actuator unit according to the invention, the function carrier (1) forms a basic element for the electromagnetic coil arrangement (3) as well as its contacting and thus, after assembly, represents a stator, which furthermore has an axial receptacle for the rotor shaft (51) in the receiving element (101).

As described above, the integration of a finished component “motor” is dispensed with in favour of a stator constructed integrally with the function carrier (1) according to the invention. Thus, significantly tighter tolerances can be maintained, since the function carrier (1) according to the invention itself accommodates the stator.

The above further development is preferably further performed in that the arrangement (5) of permanent magnets in a rotor housing with the rotor shaft (51) constitutes a rotor, which is received in the receiving element (101) after joining.

In other words, the receiving element (101) forms an axial receptacle in which the permanent magnets, which are arranged rotationally by joining, are mounted as a rotor with the rotor shaft (51) in a rotor housing which is preferably designed as a cylindrical body. This constructive measure also ensures that significantly tighter tolerances can be maintained. If an unbalance occurs due to parameters, this unbalance can be eliminated by applying (e.g. gluing on) weights.

In a preferred embodiment of the present invention, the electric actuating unit further comprises at least one first drive element (9) force-locking connected to the rotor shaft (51), wherein the first drive element (9) has a first axis (91) which is rotatably mounted in the function carrier (1).

The term “first drive element” refers to a component, which can perform a drive function or an actuating function through the rotation of the rotor shaft (51). The first axis (91) is in particular the extension of the rotor shaft (51). The first axis (91) and the rotor shaft (51) are at least force-locking/frictionally connected. In a very special embodiment, the rotor shaft (51) can extend into the first drive element (9) as the first axis (91).

In a preferred embodiment, the first drive element (9) is designed as a worm. This worm can be mechanically connected directly or indirectly to a control element or the like.

If the above embodiment is further embodied, the electric actuating unit further comprises at least one second drive element (11), wherein the second drive element (11) has a second axis (1101) which is rotatably mounted in the function carrier (1), wherein the first drive element (9) is in force-locking engagement with the second drive element (11).

The second axis (1101) of the second drive element (11) is in particular at right angles to the first axis (91) of the first drive element (9) and is mounted in the function carrier (1). Since the first drive element (9) and the second drive element (11) are mounted in the function carrier (1) according to the invention, there are only minimal tolerances. The tool always works with the coordinate origin X=0, Y=0. Therefore, no positional tolerances are added.

The second drive element (11) is preferably a gear wheel whose teeth are engaged by the worm. The second drive element (11) is in particular in functional connection with an actuating element. The phrase “in functional connection” means here that this actuating element carries out the functionality of the electric actuating unit, for example the adjustment of a flap.

In a special further development, an encoder can be arranged in or on the second drive element (11). The encoder reports the angle of rotation of the second drive element (11) to a sensor on request. Alternatively, the second drive element (11) can also be driven mechanically without an encoder or the like.

Particularly preferably, the first drive element (9) and the second drive element (11) have a single-stage gear ratio.

The precision of this gear ratio is increased by the function carrier (1) according to the invention. This reduces the naturally high power dissipation.

A further embodiment of the present invention provides that the function carrier (1) offers the possibility of mounting a bearing for a one-piece movement axis.

Such a bearing is structurally located in the centre of the assembly of the electromagnetic coil arrangement (3) and the arrangement (5) of permanent magnets provided concentrically thereto, whereby again significantly tighter tolerances can be maintained.

In particular, the one-piece axis of motion is the extended rotor shaft (51) with the first axis (91) of the first drive element (9).

In one embodiment of the invention, the electric actuating unit further comprises a contact carrier (7) attached to the function carrier (1), wherein the contact carrier (7) is electrically connected to the electromagnetic coil arrangement (3).

The contact carrier (7) is in particular a miniaturised printed circuit board on which the very thin stranded wires removed from the electromagnetic coil arrangement (3), which are therefore difficult to handle, are connected on the one hand to electrical contacts with an easily manageable dimension on the other hand. These easily manageable electrical contacts can be wires of larger diameter or stamped lead frames.

In another further embodiment of the invention, the first receiving element (101) further comprises a bearing bush in which the rotor shaft (51) is rotatably mounted.

The bearing bush can in particular be made of a material that differs from the material of the function carrier and enables, for example, friction-free and/or noiseless running of the rotor shaft (51).

In order to be able to connect the electric actuating unit according to the invention to the vehicle electrics and vehicle electronics, in another further embodiment it further comprises a control circuit board (13) which is electrically connected to the contact carrier (7). The intelligent control circuit board (13) also provides positioning data and is capable of diagnosis.

The electric actuating unit according to the invention, as described above, is functional as such without any problems. In order to better withstand the harsh operating conditions in the engine compartment of a motor vehicle, it has proved advantageous in a special embodiment if the electric actuating unit according to the invention further comprises a housing which is open towards a first side and which surrounds at least the function carrier (1) with electromagnetic coil arrangement (3), arrangement (5) of permanent magnets in a rotor housing and contact carrier (7) and shields them from the outside.

Since the housing has only an enveloping function with regard to the integral component and protects the internal structure (e.g. from water, dust, ambient chemicals), the design can be very form-fitting.

The housing is preferably produced as an injection moulded part. The phrase “open towards a first side” means in the sense of the present invention that the housing for enclosing the function carrier (1) with arranged functional components is open, in particular on the upper side.

In a further development of the above embodiment, the control circuit board (13) can be attached to the housing in such a way that slots are positioned to accommodate external connector pins.

Against the background of the harsh operating conditions in the engine compartment of a motor vehicle, the housing further comprises a housing cover, which closes the first open side.

It is particularly preferred if the housing has a sealed connection between the housing and the housing cover. In addition to a tight connection, a high mechanical robustness is also ensured.

The tight connection has the advantage and the effect that the electric actuating unit of this particular embodiment according to the invention is thus sealed against steam jets and similar sources, such as occur in the engine compartment of a motor vehicle. The sealed connection between the housing and the housing cover is preferably a welded or bonded or pressed connection. Depending on the area of application, however, a reversible fastening (screws, latching elements) can also be provided.

This means that further treatment of the control circuit board (13), such as painting or coating to protect it, can be dispensed with.

The size reduction described above leads to a further advantage of the present invention. Due to the compact and size-reduced design, the electric actuating unit according to the invention has a very small enclosed air volume, which can be neglected thermodynamically. Pressure equalisation elements, DAE for short, (for example semi-permeable membranes), as they have to be used in the prior art, can therefore be dispensed with in the context of the present invention. This means a considerable cost saving and significantly reduces the potential for errors.

In one embodiment, an adapter is further provided on the housing for fixing the electric actuating unit in its installation environment.

In order to make the electric actuating unit according to the invention accessible to a wide range of applications without design changes, the unit itself does not have any standardised connecting elements (e.g. screw bosses, eyelets, etc.). According to the invention, therefore, the adapter is provided to suit the respective installation environment for the special application, which adapter is attached to the electric actuating unit according to the invention on the one hand and has the necessary standard receptacles for connecting elements on the other hand. The attachment of the electric actuating unit according to the invention is thus essentially effected via the adapter.

In another embodiment, assembly time is saved by dispensing with the adapter and installing it directly in the pipe or hose line system.

Further objectives, features, advantages and possible applications will be apparent from the following description of examples of embodiments, which do not restrict the invention, based on the figures. In this context, all the features described and/or illustrated constitute the subject matter of the invention, either individually or in any combination, even irrespective of their summary in the claims or their relation back.

### BRIEF DESCRIPTION OF THE DRAWINGS

The figures show:

FIG. 1 a schematic exploded view of an electric actuating unit according to one embodiment of the invention,

FIG. 2 a schematic representation of the electric actuating unit according to the invention shown in FIG. 1 in the assembled state,

FIG. 3 a schematic representation of the function carrier 1 according to the invention.

### DETAILED DESCRIPTION OF THE INVENTION

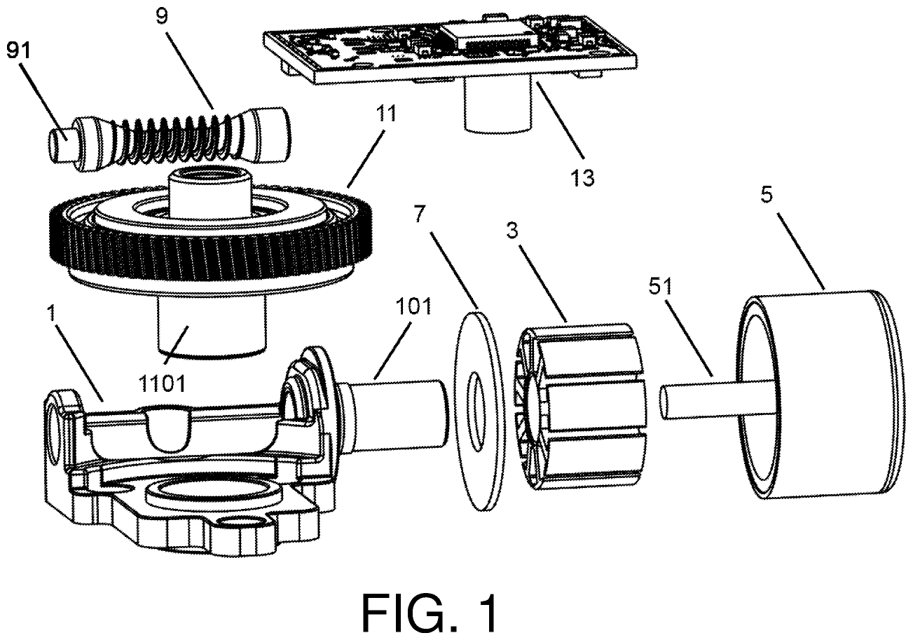

FIG. 1 shows a schematic exploded view of an electric actuating unit according to one embodiment of the invention. The central component is the function carrier 1 according to the invention, which accommodates all other functional components and precisely supports them against each other.

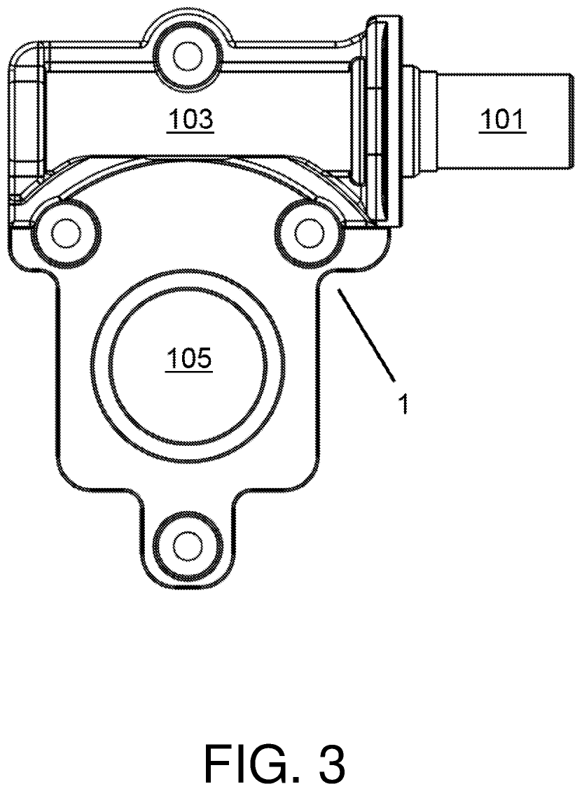

Thus, when assembling this preferred embodiment, the first drive element 9 in the form of a worm is first inserted into the corresponding recess of the second receiving element 103 (shown only in FIG. 3), its first axis 91 being supported in the function carrier 1 according to the invention.

From the side, the contact carrier 7 is pushed over the first receiving element 101 in order to then apply the electromagnetic coil arrangement 3 to the outside of the first receiving element 101, in particular force-locked pressing it on. Subsequently, the arrangement 5 of permanent magnets is mounted in a rotor housing. For this purpose, the rotor shaft 51 is guided through the interior of the first receiving element 101 and brought into engagement with the first axis 91 of the first drive element 9. At the same time, the rotor housing, which accommodates the permanent magnets, is pushed over the electromagnetic coil arrangement 3 at a defined distance.

From this structure, it becomes clear that no finished component “motor” is integrated into the electric actuating unit according to the invention. Rather, the function carrier 1 according to the invention becomes the central element of an integrally housed motor, which has less tolerance-critical areas of motor components, compared to a finished motor, such as is installed in the prior art in a generic electric actuating unit.

Furthermore, in this preferred embodiment, the second drive element 11 in the form of a gear wheel is inserted with its second axis 1101 into the corresponding recess of the third receiving element 105 in the function carrier 1 according to the invention and is simultaneously brought into engagement with the worm as the first drive element 9 via its row of teeth.

Thus, all tolerance-critical functional components are mounted in a single component, namely the function carrier 1 according to the invention.

In this embodiment, the control circuit board 13 provided in accordance with the invention is deliberately not permanently integrated, but merely electrically integrated in the electric actuating unit in accordance with the invention, in order to permit more variable use.

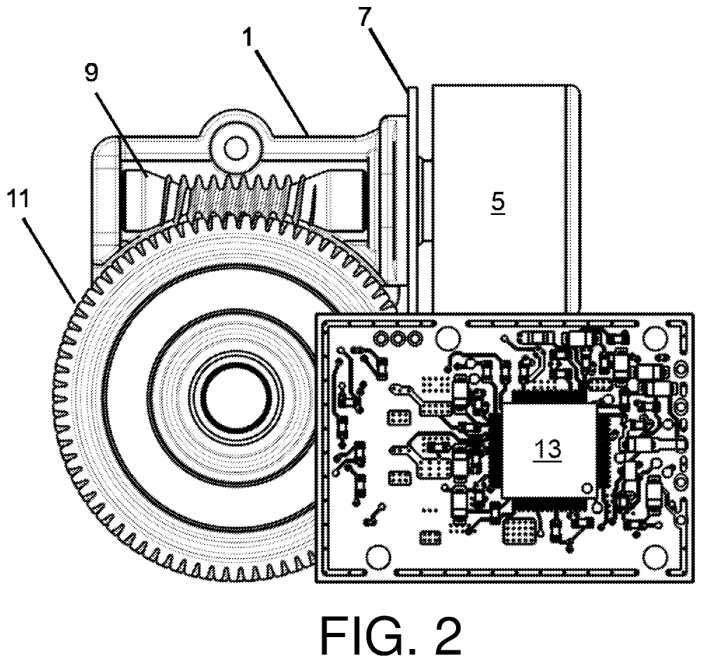

FIG. 2 shows the assembled electric actuating unit according to the invention shown in FIG. 1. This illustration clearly shows the extremely compact arrangement of the individual components in the electric actuating unit according to the invention, whereby only a part of the function carrier 1 according to the invention can be seen in this top view, in which a worm as the first drive element 9 and a gear wheel as the second drive element 11 are mounted, which are adjusted or operated via the functional motor components, namely electromagnetic coil arrangement 3 and arrangement 5 of permanent magnets in a rotor housing, which are also mounted on the function carrier 1 according to the invention.

FIG. 3 shows only the function carrier 1 according to the invention in a plan view. The function carrier 1 according to the invention is designed in one piece. All tolerance-critical details are introduced via a single tool mould and not (as is often the case in the prior art) via a tool separation.

On the right hand side, the first receiving element 101 is shown, which, in addition to the fixed, force-locking receptacle of the electromagnetic coil arrangement 3, simultaneously supports the arrangement 5 of permanent magnets in a rotor housing by means of the rotor shaft 51. In the alignment of the rotor shaft 51 is the second receiving element 103, in which the first drive element 9 is mounted. Finally, the third receiving element 105 is shown, which serves to support the second drive element 11.

The electric actuating unit according to the invention has a modular design in which, on the basis of the function carrier 1 according to the invention, this together with the electromagnetic coil arrangement 3, the arrangement 5 of permanent magnets in a rotor housing and the contact carrier 7 forms an integral component which is stable in itself and independent of external manufacturing tolerances. A special feature is the integration of an external rotor motor into the electric actuating unit according to the invention.

According to the invention, it is therefore possible to integrate this integral component built on the function carrier 1 according to the invention into other enclosure concepts according to practical requirements. The housing geometry is thus almost completely independent of the integral component built on the function carrier 1 according to the invention.

It is also possible to expand the integral component with further components and to use it variably.

The integral component built on the function carrier 1 according to the invention has an extremely compact design, as can also be seen in FIG. 2. Therefore, the contour of the housing with housing cover can be optimally adapted to the geometry of the application environment, e.g. downsized, which saves space and weight. Furthermore, there is no need to use a so-called pressure equalisation element (DAE).

The compact and robust design of the electric actuating unit according to the invention also has a very positive effect on noise emission, which plays an increasingly important role in the course of the electrification of motor vehicles.

The electric actuating unit according to the invention is used, for example, for positioning sensors. Since each individual actuating angle can be kept currentless, the electric actuating unit according to the invention replaces the usual magnetic switch not only in electric motor vehicles.

The electric actuating unit according to the invention can replace any conventional actuator unit from the prior art. In particular, solenoid valves, for example, can be operated, since any position can be operated without current. This results in no load on the on-board network of a motor vehicle, e.g. in start/stop mode.

### LIST OF REFERENCE SIGNS

1 function carrier

101 first receiving element

103 second receiving element

105 third receiving element

3 electromagnetic coil arrangement

5 arrangement of permanent magnets in a rotor housing

51 rotor shaft

7 contact carrier

9 first drive element

91 first axis

11 second drive element

1101 second axis

13 control circuit board

1. An electric actuating unit comprising
a function carrier which has a first receiving element
an electromagnetic coil arrangement fixedly mounted on the first receiving element, and
an assembly of permanent magnets concentrically arranged around the electromagnetic coil assembly in a rotor housing, the assembly having a rotor shaft rotatably supported in the first receiving element,
wherein the electromagnetic coil assembly and the assembly of permanent magnets in a rotor housing form an external rotor motor.

2. The electric actuating unit according to claim 1, wherein the function carrier forms a base element for the electromagnetic coil arrangement as well as its contacting and thus, after assembly, constitutes a stator which further has an axial receptacle for the rotor shaft in the receiving element.

3. The electric actuating unit according to claim 2, wherein the arrangement of permanent magnets in a rotor housing with the rotor shaft constitutes a rotor which is accommodated in the receiving element after assembly.

4. The electric actuating unit according to claim 1, further comprising
at least one first drive element connected force-locking to the rotor shaft, the first drive element having a first axis which is rotatably mounted in the function carrier.

5. The electric actuating unit according to claim 4, further comprising
at least one second drive element, the second drive element having a second axis which is rotatably mounted in the function carrier, the first drive element being in force-locking engagement with the second drive element.

6. The electric actuating unit according to claim 5, wherein the first drive element and the second drive element have a single-stage gear ratio.

7. The electric actuating unit according claim 1, wherein the function carrier offers the possibility of mounting a bearing for a one-piece movement axis.

8. The electric actuating unit according to claim 1, further comprising
a contact carrier attached to the function carrier, wherein the contact carrier is electrically connected to the electromagnetic coil assembly.

9. The electric actuating unit according to claim 1, wherein the first receiving element further comprises a bearing bush in which the rotor shaft is rotatably mounted.

10. The electric actuating unit according to claim 1, further comprising
a control circuit board which is electrically connected to the contact carrier.

11. The electric actuating unit according to claims 1, further comprising
a housing open towards a first side, which surrounds at least the function carrier with electromagnetic coil arrangement, arrangement of permanent magnets in a rotor housing and contact carrier and shields it from the outside.

12. The electric actuating unit according to claim 11, wherein the control circuit board is mounted on the housing so as to position slots for receiving external connector pins.

13. The electric actuating unit according to claim 11, wherein the housing further comprises a housing cover closing the first open side.

14. The electric actuating unit of claim 13, wherein the housing comprises a sealed connection between the housing and the housing cover.

15. The electric actuating unit according to claim 11, further comprising,
an adapter provided on the housing for mounting the electrical actuator unit in its mounting environment.
